(19) United States
(12) Patent Application Publication
(10) Pub. No.: US 2013/0288588 A1
(43) Pub. Date: Oct. 31, 2013

(54) SERVER SYSTEM AND FAN CONTROL METHOD AND A FAN CONTROL METHOD THEREOF

(71) Applicants: CHIH-CHUNG SHIH, Tu-Cheng (TW); CHUN-MING CHEN, Tu-Cheng (TW)

(72) Inventors: CHIH-CHUNG SHIH, Tu-Cheng (TW); CHUN-MING CHEN, Tu-Cheng (TW)

(73) Assignee: HON HAI PRECISION INDUSTRY CO., LTD., Tu-Cheng (TW)

(21) Appl. No.: 13/587,946

(22) Filed: Aug. 17, 2012

(30) Foreign Application Priority Data
Apr. 27, 2012 (TW) 101115236

(51) Int. Cl. G06F 1/20; F24F 11/04

(52) U.S. Cl. 454/256; 361/679.48

(57) ABSTRACT

A server system includes a server cabinet, several fan control boards, several servers connected to one fan control board, an uninterruptible power supply, a network switch, and several fan groups coupled to the server cabinet. The fan control board includes a determining module to determine whether the fan control board has received a control signal, and a controlling module. The server includes a first detecting module to detect performance characteristics, a first obtaining module to obtain a control signal, and a first transmitting module to transmit the control signal. Each fan group includes several fans to cool the servers, the uninterruptible power supply, or the network switch. When determining that the fan control board received a control signal, the controlling module of the fan control board controls the fan group to rotate at a corresponding speed; otherwise controlling the fan group to rotate at a constant speed.

### BACKGROUND

1. Related Applications

Related subject matter is disclosed in a co-pending U.S. patent application with Attorney Docket Number US41402 and titled SERVER SYSTEM WITH FAN SPEED CONTROL, filed on 2011 Dec. 27, which has the same assignee as the current application.

2. Technical Field

The present disclosure relates to a server system with a fan control system for controlling rotation speeds of the fans and fan control methods thereof.

3. Description of Related Art

Server systems are commonly used to process and store data or information in networks. A server system includes a server cabinet and a number of servers accommodated in the server cabinet. A number of fans are arranged in the back of the server cabinet for cooling the servers during operation. Although conventional server systems satisfy basic requirements, a new type of server systems is still desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a back view of a server system, partially cut away, in accordance with an exemplary embodiment.

FIG. 2 is a block diagram of the server system of FIG. 1.

FIG. 3 is a flowchart of a fan control method according an exemplary embodiment.

### DETAILED DESCRIPTION

Embodiments of the present disclosure are now described in detail, with reference to the accompanying drawings.

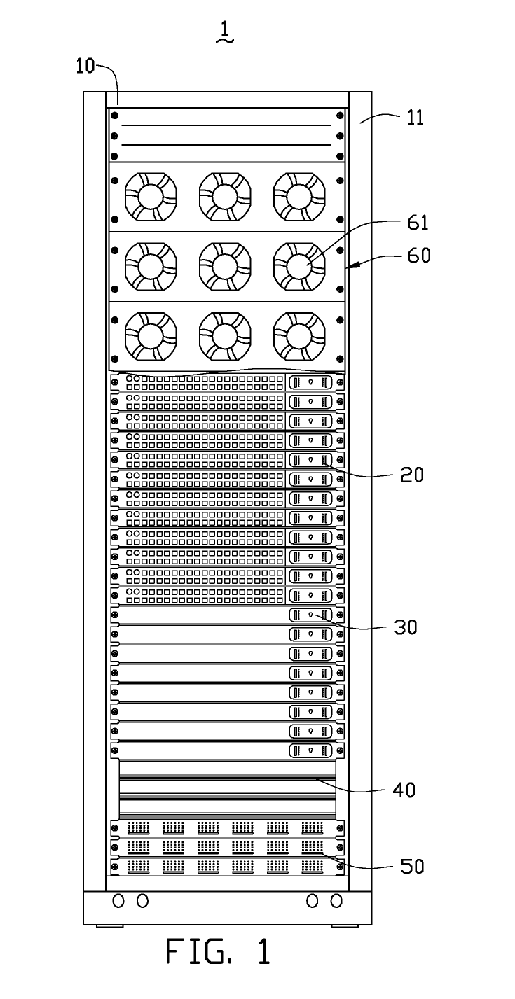

Referring to FIG. 1, a back view of a server system 1 according to an exemplary embodiment is illustrated. The server system 1 includes a server cabinet 10 with two parallel racks 11, a number of servers 20, a number of storage units 30, a number of uninterruptible power supplies (UPS) 40, and a number of network switches 50.

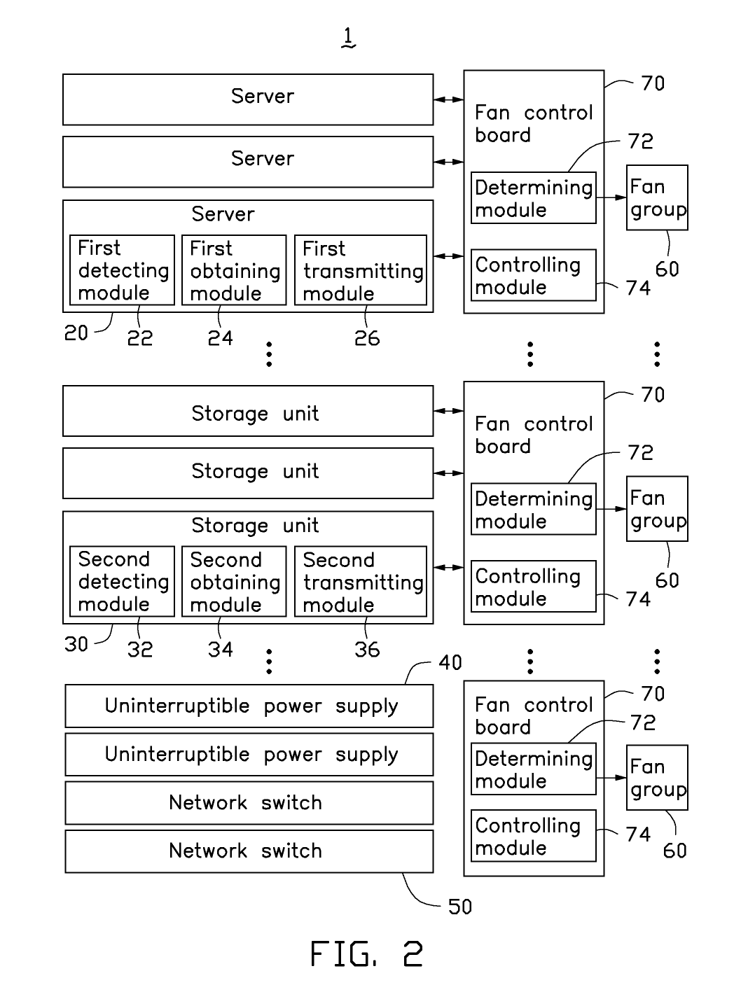

Referring also to FIG. 2, the server system 1 further includes a number of fan groups 60 coupled to a rear side of the server cabinet 10 and a number of fan control boards 70 respectively connected to the fan groups 60. The fan groups 60 each include a number of fans 61 to provide a horizontal airflow for cooling the servers 20, the storage units 30, the UPSs 40, or the network switches 50 which are substantially aligned with the fan groups 60. In the embodiment, each fan group 30 may include three, four, or five fans 31 arranged in a row, and the size of each fan 31 may be 92 mm*92 mm or 120 mm*120 mm.

Each server 20 is connected to one of the fan control boards 70 and includes a first detecting module 22, a first obtaining module 24, and a first transmitting module 26. The first detecting module 22 detects a number of performance characteristics of the server 20. In the embodiment, the performance characteristics may include such things as operating temperatures, usage rates, and data accessing speeds of the server 20. The first obtaining module 24 obtains a rotation speed control signal according to the performance characteristics provided by the detecting module 22. The first transmitting module 26 automatically transmits the rotation speed control signal to the fan control board 70.

Each storage unit 30 is connected to one of the fan control boards 70 and includes a second detecting module 32, a second obtaining module 34, and a second transmitting module 36. The second detecting module 32 detects a number of performance characteristics of the storage unit 30. In the embodiment, the performance characteristics may include such things as operating temperatures, usage rates, and data accessing speeds of the storage units 30. The second obtaining module 34 obtains a rotation speed control signal according to the performance characteristics provided by the detecting module 32. The second transmitting module 36 atomically transmits the rotation speed control signal to the fan control board 70.

Each fan control board 70 includes a determining module 72 and a controlling module 74. The determining module 72 determines whether the fan control board 70 has received a rotation speed control signal. When the determining module 72 determines that the fan control board 70 has received a rotation speed control signal, the controlling module 74 controls the fan group 60 which is connected to the fan control board 70 to rotate at a corresponding speed, thereby satisfying heat dissipation needs of the servers 20 and the storage units 30. Otherwise, the controlling module 74 controls the fan group 60 to rotate at a constant speed, thereby satisfying heat dissipation needs of the UPSs 40 and the network switches 50.

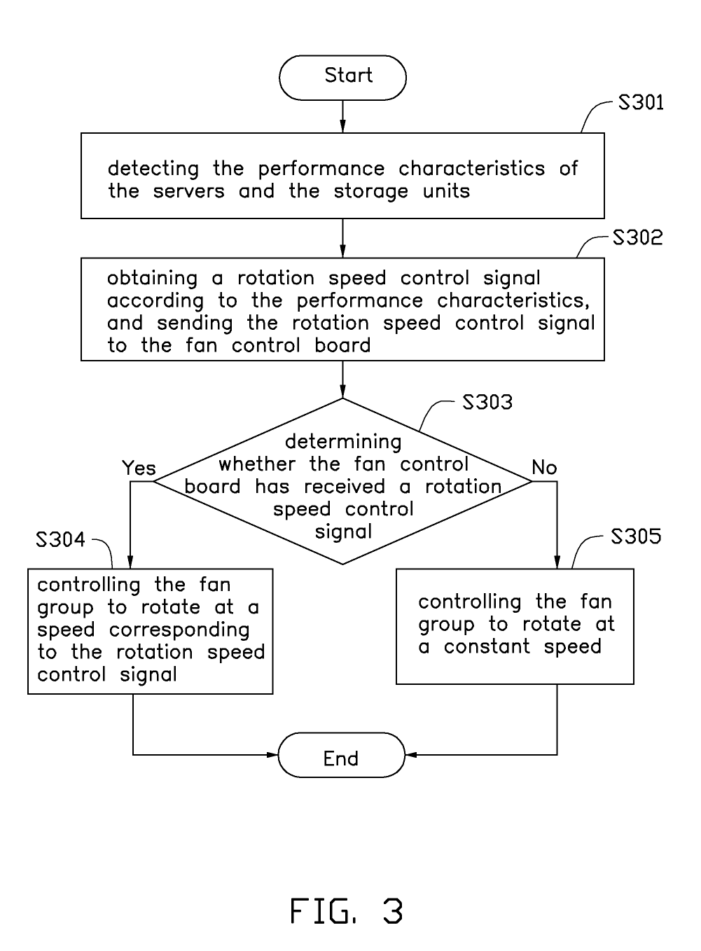

Referring to FIG. 3, a flowchart of a fan control method according an exemplary embodiment is illustrated.

In step S301, the first detecting module 22 and the second detecting module 32 detects a number of performance characteristics of the servers 20 and the storage units 30. The performance characteristics may include such things as operating temperatures, usage rates, and data accessing speeds of the servers 20 and the storage units.

In step S302, the first obtaining module 24 or the second obtaining module 34 obtains a rotation speed control signal according to the detected performance characteristics, and the first transmitting module 26 or the second transmitting module 36 automatically transmits the rotation speed control signal to the fan control board 70.

In step S303, the determining module determines whether the fan control board 70 has received a rotation speed control signal. If so, the step goes to Step S304; otherwise, the step goes to Step S305.

In step S304, the controlling module controls 74 controls the fan group 60 which is connected to the fan control board 70 to rotate at a corresponding speed, thereby satisfying heat dissipation needs of the servers 20 and the storage units 30.

In step S305, the controlling module controls 74 controls the fan group 60 which is connected to the fan control board 70 to rotate at a constant speed, thereby satisfying heat dissipation needs of the UPSs 40 and the network switches 50.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A server system comprising:
a server cabinet;
a plurality of fan control boards each comprising:
a determining module to determine whether the fan control board has received a rotation speed control signal; and
a controlling module;
a plurality of servers connected to one of the plurality of fan control boards, each server comprising:
a first detecting module to detect a plurality of performance characteristics of the plurality of servers;
a first obtaining module obtains a rotation speed control signal according to the plurality of performance characteristics; and
a first transmitting module to transmit the rotation speed control signal to the one of the plurality of fan control boards;
at least one uninterruptible power supply;
at least one network switch; and
a plurality of fan groups coupled to a rear side of the server cabinet and each fan group comprising a plurality of fans to provide a horizontal airflow to cool the plurality of servers, the at least one uninterruptible power supply, or the at least one network switch which are substantially aligned with the plurality of fan groups;
wherein when the determining module of one of the plurality of fan control boards determines that the fan control board has received a rotation speed control signal, the controlling module of the one of the plurality of fan control boards controls the fan group to rotate at a speed corresponding to the rotation speed control signals;
when the determining module of one of the plurality of fan control boards determines that the fan control board has not received a rotation speed control signal, the controlling module of the one of the plurality of fan control boards controls the fan group to rotate at a constant speed.

2. The server system as described in claim 1, wherein the server cabinet comprises two parallel racks, and the plurality of servers are located between the two racks.

3. The server system as described in claim 1, wherein each fan group comprises three, four, or five fans arranged in a row.

4. The server system as described in claim 3, wherein the size of each fan is 92 mm*92 mm.

5. The server system as described in claim 3, wherein the size of each fan is 120 mm*120 mm.

6. The server system as described in claim 1, wherein the plurality of fan control boards are integrated on a circuit board.

7. The server system as described in claim 1, wherein the plurality of performance characteristics of the plurality of servers comprise operating temperatures, usage rates, and data accessing speeds.

8. The server system as described in claim 1, further comprising a plurality of storage units that comprises a second detecting module to detect a plurality of performance characteristics of the plurality of storage units, a second obtaining module obtains a rotation speed control signal according to the plurality of performance characteristics, and a second transmitting module to transmit the rotation speed control signal to the one of the plurality of fan control boards, and the plurality of fans is capable of providing a horizontal airflow to cool which are substantially aligned with the plurality of fan groups.

9. The server system as described in claim 8, wherein the plurality of performance characteristics of the plurality of storage units comprise operating temperatures, usage rates, and data accessing speeds.

10. A fan control method applied in a server system which comprises a plurality of servers, a plurality of storage units, at least one uninterruptible power supply, at least one network switch, a plurality of fan control boards and a plurality of fan groups comprising a plurality of fans to provide a horizontal airflow, the method comprising:
detecting a plurality of performance characteristics of the plurality of servers and the plurality of storage units;
obtaining a rotation speed control signal according to the plurality of performance characteristics, and transmitting the rotation speed control signal to one of the plurality of fan control boards;
determining whether the fan control board has received the rotation speed control signal;
controlling the corresponding one of the plurality of fan groups to rotate at a speed corresponding to the rotation speed control signal when determining that the fan control board has received the rotation speed control signal; and
controlling the corresponding one of the plurality of fan groups to rotate at a constant speed determining that the fan control board has not received the rotation speed control signal.

11. The fan control method as described in claim 10, wherein the plurality of performance characteristics of the plurality of servers and the plurality of storage units comprise operating temperatures, usage rates, and data accessing speeds.

12. A fan control method applied in a server system which comprises a plurality of servers, at least one uninterruptible power supply, at least one network switch, a plurality of fan control boards and a plurality of fan groups comprising a plurality of fans to provide a horizontal airflow, the method comprising:
detecting a plurality of performance characteristics of the plurality of servers;
obtaining a rotation speed control signal according to the plurality of performance characteristics, and transmitting the rotation speed control signal to one of the plurality of fan control boards;
determining whether the fan control board has received the rotation speed control signal;
controlling the corresponding one of the plurality of fan groups to rotate at a speed corresponding to the rotation speed control signal when determining that the fan control board has received the rotation speed control signal; and
controlling the corresponding one of the plurality of fan groups to rotate at a constant speed determining that the fan control board has not received the rotation speed control signal.

13. The fan control method as described in claim 12, wherein the plurality of performance characteristics of the plurality of servers comprise operating temperatures, usage rates, and data accessing speeds.
